(19) United States
(12) Patent Application Publication
(10) Pub. No.: US 2006/0283330 A1
(43) Pub. Date: Dec. 21, 2006

(54) COFFEE MAKER WITH HEIGHT ADJUSTMENT MECHANISM

(75) Inventor: Yu-Yuan Lin, Tainan (TW)

Correspondence Address: NIKOLAI & MERSEREAU, P.A., 900 SECOND AVENUE SOUTH, SUITE 820, MINNEAPOLIS, MN, 55402, US

(73) Assignee: UNI-SPLENDOR CORP., Tainan (TW)

(21) Appl. No.: 11/160,341

(22) Filed: Jun. 20, 2005

(51) Int. Cl. A47J 31/44

(52) U.S. Cl. 99/279

(57) ABSTRACT

A coffee maker comprises a height adjustment mechanism for accommodating mugs with different heights including an internal casing, a gear in the casing, a column secured to the brewing assembly and the casing, the column including a rack meshed the gear, a staged knob seat interconnected the casing and the housing, the knob seat including flutes around inner surface of an outer stage, a shaft inserted through the knob seat to connect the gear, a knob including a receptacle securely engaged head of the shaft, upper and lower recesses the receptacle disposed therebetween, and two push buttons each including a spring-biased trigger partially projected from the recess, and a ridge engaged a valley of the teeth. Pressing the triggers into the recesses until the ridges clear the flutes, and turning the knob and the shaft will rotate the gear to raise or lower the rack and the brewing assembly.

### BACKGROUND OF THE INVENTION

1. Field of Invention

The present invention relates to coffee makers and more particularly to such a coffee maker having a mechanism for adjusting a distance between a brewing assembly and a stand so as to accommodate mugs with different heights.

2. Related Art

There is a commercially available coffee maker including a brewing assembly extended from one side of an upper portion of housing and a stand extended from one side of a lower portion thereof below the brewing assembly. Typically, a distance between the brewing assembly and the stand is fixed and a mug having a height less than the distance is adapted to place on the stand. However, it is often that many tall mugs cannot place on the stand because its height is larger than the distance. This often bothers users. Thus, the need for improvement still exists.

### SUMMARY OF THE INVENTION

It is therefore an object of the present invention to provide a coffee maker having a mechanism for adjusting a distance between a brewing assembly and a stand with a mug placed thereon. The present invention can accommodate mugs with different heights.

The above and other objects of the present invention are realized by providing a coffee maker comprising a housing including a water reservoir, a water heating device, a supply unit, and a stand on its base, the stand being adapted to support a container; and a vertically movable brewing assembly laterally projected from an upper portion of the housing to dispose above the stand, the brewing assembly including a holder for receiving one or more coffee bags or coffee powder, and a bottom outlet opening; and a height adjustment mechanism including: a casing disposed within the water reservoir and including a longitudinal groove; a gear including a central bore rotatably disposed in the casing; a column having one portion secured to the brewing assembly and the other portion inserted into the groove for fastening, the column including a rear rack meshed the gear, a longitudinal internal channel in fluid communication with both the water reservoir and the brewing assembly; a staged cylindrical knob seat interconnected the casing and the housing, the knob seat including a plurality of flutes disposed around an inner surface of an outer stage; a shaft including a shank inserted through the knob seat and the bore for securing to the gear, and a head; a cylindrical knob including an internal receptacle securely engaged the head of the shaft, a pair of recesses disposed at upper and lower portions with the receptacle disposed between the recesses; an external knob secured to the knob seat; and two push buttons each including an outer spring-biased trigger partially projected from the recess, an extension projected from the trigger to dispose proximate the flutes, and a ridge along an outer surface of the extension to engage a valley between two adjacent flutes when the trigger is not pressed, whereby pressing the triggers into the recesses until the ridges clear the flutes, and either turning the knob and the shaft in one direction will rotate the gear to raise the rack and the brewing assembly or turning the knob and the shaft in the other direction will rotate the gear to lower the rack and the brewing assembly.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of a coffee maker according to the invention;

FIG. 2 is an exploded perspective of the coffee maker;

FIG. 3 is a side view in part section of the coffee maker shown in FIG. 1;

FIG. 4 is a top view in part section of the coffee maker shown in FIG. 1;

FIG. 5 is a longitudinal sectional view of the coffee maker shown in FIG. 1;

FIG. 6 is a longitudinal sectional view of the knob of the height adjustment mechanism where the knob is not pressed;

FIG. 7 is a side view in part section of the knob of the height adjustment mechanism of the coffee maker shown in FIG. 1 for illustrating a vertical movement of the brewing assembly by turning the knob;

FIG. 8 is a view similar to FIG. 6 where the knob has been pressed; and

FIG. 9 is a view similar to FIG. 6 where the ridges have cleared the flutes in response to the knob pressing such that a subsequent turning of the knob for adjusting a distance between the brewing assembly and the stand is made possible.

### DETAILED DESCRIPTION OF THE INVENTION

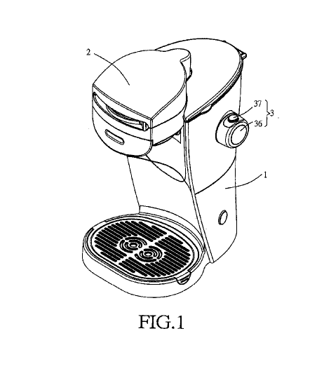

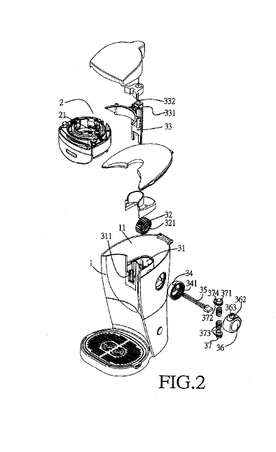

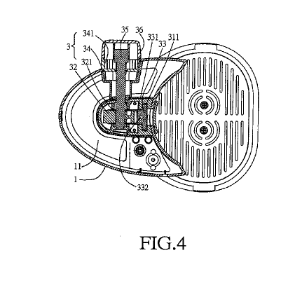

Referring to FIGS. 1 to 5, a coffee maker in accordance with a preferred embodiment of the invention comprises a housing 1, a brewing assembly 2, and a height adjustment mechanism 3. Each component is discussed in detailed below.

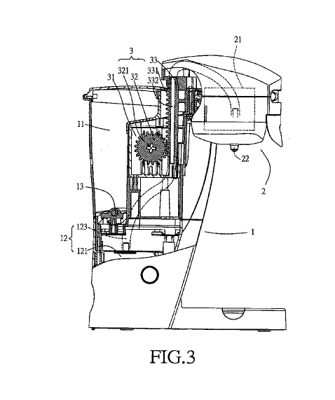

Referring to FIGS. 3 and 5, within the housing 1 there are provided an upper water reservoir 11, a heating device 13 in a lower portion of the water reservoir 11 for heating water, and a supply unit 12. The supply unit 12 includes a pump 121, an inlet duct 122 interconnecting the pump 121 and the water reservoir 11, and an outlet duct 123 wherein the pump 121 is adapted to activate to supply hot water from the water reservoir 11 to the brewing assembly 2 via the inlet duct 122 and the outlet duct 123.

The brewing assembly 2 is provided in upper left side of the housing 1 (see FIG. 1). The brewing assembly 2 is connected to the height adjustment mechanism 3 in the housing 1 and is adapted to be raised or lowered by operating the height adjustment mechanism 3 as detailed later. The brewing assembly 2 comprises a holder 21 for receiving a coffee bag or coffee powder, and an outlet opening 22. A stand on the base of the housing is disposed below the outlet opening 22. Also, a mug is adapted to place on the stand for collecting coffee extract flowed from the outlet opening 22.

The height adjustment mechanism 3, as the subject of the invention, comprises the following components. A casing 31 is provided within the water reservoir 11 and comprises a longitudinal groove 311 of T-section. A gear 32 having a central bore 321 of cross-section is rotatably provided in the casing 31. A column 33 has one portion secured to the brewing assembly 2 and the other portion inserted into the groove 311 for fastening. The column 33 comprises a rear rack 331 meshed the gear 32, a longitudinal internal channel 332 in fluid communication with the outlet duct 123 such that hot water can flow to the brewing assembly 2 via the channel 332 after flowing through the outlet duct 123.

A staged cylindrical knob seat 34 has its inner end secured to the casing 31 and its outer end secured to the housing 1. The knob seat 34 comprises a plurality of flutes 341 provided around the inner surface of an outer stage. A shaft 35 has a shank of cross-section tightly inserted through the knob seat 34 and the bore 321 for securing to the gear 32, and a plate shaped head. A cylindrical knob 36 comprises an internal receptacle 361 shaped to securely engage the head of the shaft 35, two pairs of recesses 363 and cavities 362 inside the recess 363 provided at both upper and lower portions with the receptacle 361 disposed therebetween. The knob 36 has its inner end matingly secured to the knob seat 34. Two push buttons 37 each comprises an outer trigger 371 projected from the recess 363, an extension 372 projected from the trigger 371 to dispose proximate the flutes 341, a spring 373 disposed in the cavity 362 and biased between the receptacle 361 and the trigger 371, and a ridge 374 along an outer surface of the extension 372 to engage a valley between any two adjacent flutes 341 when the trigger 371 is not pressed.

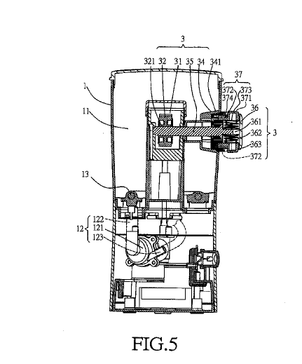

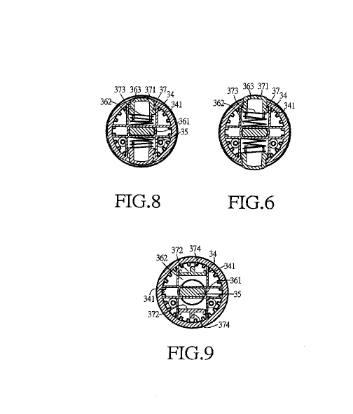

Assembly of the height adjustment mechanism 3 will be described in detailed below by referring to FIGS. 3 to 6. First, secure the column 33 to the brewing assembly 2. Next, insert a portion of the column 33 into the groove 311 for fastening. Mount the gear 32 in the casing 31 to mesh the rack 331 (as shown in FIG. 3). Connect the inlet duct 122 between the pump 121 and the water reservoir 11. Connect the outlet duct 123 to the holder 21. Mount the knob seat 34 between the casing 31 and the housing 1. Insert the shaft 35 through the knob seat 34 and the bore 321 for securing to the gear 32. A portion of the shaft 35 projecting from the bore 321 is rotatably pivoted to the casing 31. Place each spring 373 in each corresponding cavity 362. Place each trigger 371 in each corresponding recess 363. The trigger 371 is then partially projected from the recess 363 due to the expansion of the spring 373. Put the receptacle 361 on the head of the shaft 35 for fastening with the ridge 374 on the extension 372 meshed a valley between any two adjacent flutes 341. In this position, a turning of the knob 36 is inhibited since the trigger 371 is partially projected from the recess 363. The knob 36 is thus rotatably secured to the knob seat 34.

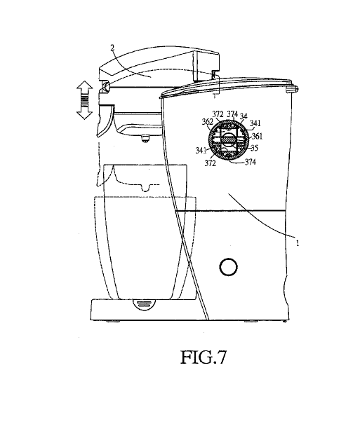

Referring to FIGS. 7 to 9, raising and lowering operations of the height adjustment mechanism 3 will be described in detailed below. First, press the triggers 371 completely into the recesses 363 (see FIG. 8) until the ridges 374 clear the flutes 341 (see FIG. 9). Next, turn both the knob 36 and the shaft 35 in one direction (e.g., clockwise). And in turn the gear 32 rotates to raise the rack 331. As such, both the column 33 and the coupled brewing assembly 2 raise. As a result, a distance between the outlet opening 22 and the stand is increased. At this position, a tall mug can be placed on the stand. To the contrary, a counterclockwise turning of the knob 36 can decrease the distance so as to accommodate a short mug to be placed on the stand.

While the invention herein disclosed has been described by means of specific embodiments, numerous modifications and variations could be made thereto by those skilled in the art without departing from the scope and spirit of the invention set forth in the claims.

What is claimed is:

1. A coffee maker comprising:
a housing including a water reservoir, a water heating device, a supply unit, and a stand on its base, the stand being adapted to support a container; and
a vertically movable brewing assembly laterally projected from an upper portion of the housing to dispose above the stand, the brewing assembly including a holder for receiving one or more coffee bags or coffee powder, and a bottom outlet opening; and
a height adjustment mechanism including:
a casing disposed within the water reservoir and including a longitudinal groove;
a gear including a central bore rotatably disposed in the casing;
a column having one portion secured to the brewing assembly and the other portion inserted into the groove for fastening, the column including a rear rack meshed the gear, a longitudinal internal channel in fluid communication with both the water reservoir and the brewing assembly;
a staged cylindrical knob seat interconnected the casing and the housing, the knob seat including a plurality of flutes disposed around an inner surface of an outer stage;
a shaft including a shank inserted through the knob seat and the bore for securing to the gear, and a head;
a cylindrical knob including an internal receptacle securely engaged the head of the shaft, a pair of recesses disposed at upper and lower portions with the receptacle disposed between the recesses;
an external knob secured to the knob seat; and
two push buttons each including an outer spring-biased trigger partially projected from the recess, an extension projected from the trigger to dispose proximate the flutes, and a ridge along an outer surface of the extension to engage a valley between two adjacent flutes when the trigger is not pressed,
whereby pressing the triggers into the recesses until the ridges clear the flutes, and either turning the knob and the shaft in one direction will rotate the gear to raise the rack and the brewing assembly or turning the knob and the shaft in the other direction will rotate the gear to lower the rack and the brewing assembly.

2. The coffee maker of claim 1, wherein the supply unit includes a pump, an inlet duct interconnecting the pump and the water reservoir, and an outlet duct connected to the brewing assembly.

3. The coffee maker of claim 1, wherein the bore of the gear has a cross section, and the shank of the shaft has a cross section.
